(19) United States
(12) Patent Application Publication
(10) Pub. No.: US 2005/0057489 A1
(43) Pub. Date: Mar. 17, 2005

(54) COOPERATIVE KEYBOARD AND TOUCHPAD CONTROL METHOD

(76) Inventors: Shao-Tsu Kung, Taipei City (TW); Cheng-Sung Lee, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/605,045

(22) Filed: Sep. 3, 2003

(51) Int. Cl. G09G 5/00

(52) U.S. Cl. 345/156

(57) ABSTRACT

A method detects for an event of a key of a keyboard. Key events include a make event executed when a key is depressed, a break event executed when a key is released, and a repeat event executed while a key is depressed for longer than a repeat threshold time. The touchpad is deactivated upon detection of the make event, and deactivated upon detection of the break event when not receiving input. The touchpad is reactivated immediately after a deactivation interval has elapsed. The touchpad is normally activated, and temporary deactivation is followed by reactivation.

### BACKGROUND OF INVENTION

1. Field of the Invention

The present invention relates to computer, and more specifically, to a computer having keyboard and touchpad input devices.

2. Description of the Prior Art

Computer input devices are constantly being developed and refined to simplify the human-machine interface. Mice, drawing palettes, and touchpads to name a few have all been developed to allow usersconvenience beyond that found in a typical keyboard. As using multiple input devices is the norm, making these devices work together harmoniously is vital.

Managing operation of a touchpad input device with a computer is well known. U.S. Pat. No. 5,327,161 to Logan et al., which is included herein by reference, teaches this in detail. Managing cooperation of a touchpad with a keyboard is less developed, but equally important.

Conventionally, cooperative operation of a touchpad-type input device with a keyboard has been either unmanaged or controlled somewhat by a hot key. Unmanaged input simply has both the touchpad and keyboard responsive to input at all times. Regarding hot key controlled input, please refer to FIG. 1 illustrating a state-of-the-art note-book computer 10. The computer 10 includes a keyboard 12, a touchpad 14 complete with mouse-style support buttons 16, a display 18, and a hot key 20. All of these components are installed into a housing 24. Naturally, the computer 10 includes internal electronics 22 such as a central processing unit (CPU), a random access memory (RAM), and a hard drive for realizing functional operation including control of the keyboard 12 and touchpad 14. Alternatively, an external touchpad 26 can be connected by way of a wired or wireless connection 28 (although this type of touchpad is more commonly used in desktop computers). Activation of the touchpad 14, 26 and its associated buttons is toggled by way of the hot key 20. When a user is working exclusively with the keyboard 12, they may wish to press the hot key 20 to turn off the touchpad 14, 26 to avoid accidental input. Subsequently, when the user decides that they want to use the touchpad 14, 26 or its buttons, they simply press the hot key 20 again to turn them on.

The main problem that the hot key 20 solves is that of accidental input via the touchpad 14, 26. That is, while typing with the keyboard 12, the user may accidentally trigger the touchpad 14, 26 which usually results in moving the cursor to an undesired location or executing an undesired operation. In addition, the touchpad 14, 26 cannot discriminate between a human finger and a loose sleeve cuff or wristwatch, making this situation even more aggravating to the user. While the hot key 20 does indeed prevent such unintended touchpad input, it does so in a way that further inconveniences the user. For example, the user may forget that the touchpad 14, 26 has been turned off and then attempt to use it only to have to hit the hot key 20 after realizing that the touchpad 14, 26 is unresponsive. On the other hand, the user may assume that they have already turned off the touch pad 14, 26, only to unintentionally execute a program moments later. At first glance, the hot key solution may appear suitable, however, such a solution introduces new problems.

Currently, cooperative control of a touchpad and keyboard, when provided, relies mainly on a hot key.

### SUMMARY OF INVENTION

It is therefore a primary objective of the claimed invention to provide a cooperative keyboard and touchpad control method to automatically facilitate intuitive user input.

Briefly summarized, the claimed invention includes detecting for an event of at least a key of a keyboard. Such key events include a make event executed when a key is depressed, a break event executed when a key is released, and a repeat event executed while a key is depressed for longer than a repeat threshold time. The claimed invention further includes deactivating the touchpad upon detection of the make event, deactivating the touchpad upon detection of the break event when the touchpad is not receiving input, and reactivating the touchpad immediately after a deactivation interval has elapsed. The touchpad is normally activated, and temporary deactivation is followed by reactivation.

According to the claimed invention,a computing device comprises a housing, a processor including a timer, and a memory fixed in the housing, a keyboard connected to the processor, a touchpad connected to the processor, and a program stored in the memory and executable by the processor for performing the claimed method.

It is an advantage of the claimed invention that the touchpad is conditionally and temporarily deactivated, and manualtoggling of a hot key is not required.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective view of a prior art notebook computer.

FIG. 2 is block diagram of a computer according to the present invention.

FIG. 3 is a schematic diagram of an operation of the control program of FIG. 2.

FIG. 4 is a flowchart of an event procedure according to the present invention.

FIG. 5 is a flowchart of a timer event according to the present invention.

FIG. 6 is a timing diagram according to FIG. 3-5.

### DETAILED DESCRIPTION

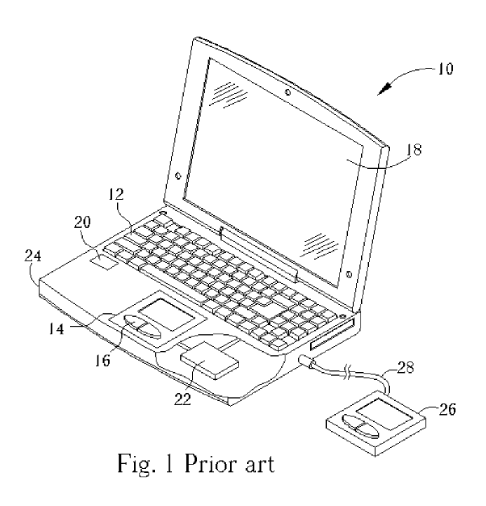

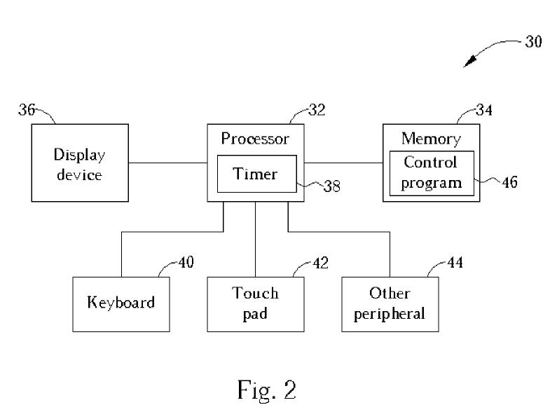

FIG. 2 illustrates the main blocks of a computer 30 capable of performing the present invention method. Minor blocks and sub-blocks are well known in the art and omitted for clarity. The computer 30 includes a processor (e.g. CPU) 32, a memory 34, and a display device 36. The processor 32 includes a timer (counter) 38, however this device may also be supplied outside the processor 32. The memory 34 can be a random-access memory, such as SDRAM or flash memory, or a read-only memory. The memory may be external to the processor 32 as depicted or may be a memory internal to the processor. Further provided to facilitate user input/output are several peripheral devices: a keyboard 40, a touchpad 42, and another device 44 (e.g. mouse). A control program 46 is provided in the memory 46 for controlling operations of the keyboard 40 and touchpad 42 according to the present invention method. The computer 30 can be provided in a compact notebook housing such as that shown in FIG. 1, as a larger desktop computer, or as a small handheld device (i.e. PDA, mobile phone). As a whole, the computer 30 is capable of performing a wide variety of operations and computations.

The keyboard 40 comprises multiple keys (see FIG. 1 for example) and outputs a digital signal to the processor 32 corresponding to key states. This can be realized by, for example, the well-known keyboard basic input output system (BIOS), although other methods are not excluded. The keyboard 40 is capable of generating three events at the processor 32: (1) a make event generated at the instant that a key of the keyboard 40 is depressed, (2) a break event generated at the instant a key is released, and (3) a repeat event generated after a key is held down for longer than a repeat threshold time. In the following a single key is discussed, as the effect of multiple keys being depressed simultaneously or sequentially is equivalent to a single key being depressed according to the principle of superposition.

The touchpad 42 is of a standard variety and may include specialized supporting buttons, such as those used to emulate mouse input. The touchpad 42 can be a wired or wireless device such as touchpads 14, 26 illustrated in FIG. 1. The touchpad 42 utilizes an electrode grid or other device to output a position or movement signal to the processor 32 for interpretation. Irrespective of the inner workings, the touchpad 42 allows a user to sweep a finger or stylus across its surface to generate the position or movement signal. In the following, the touchpad 42 is active (turned on) by default, and temporarily deactivated (turned off) according to the present invention method.

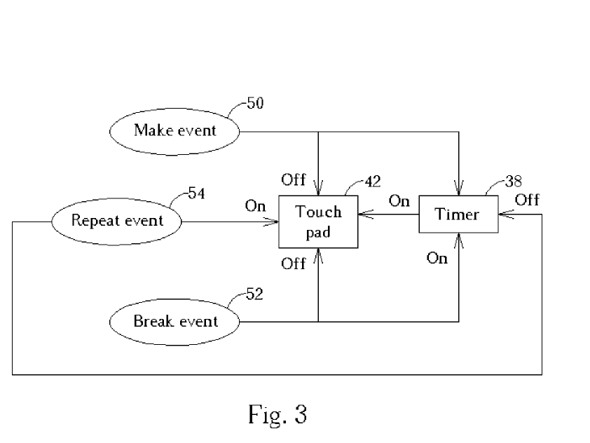

Cooperative operation of the touchpad 42 and the keyboard 40 is achieved by the control program 46. Please refer to FIG. 3 showing a schematic diagram of operations of the control program 46. As mentioned, the keyboard 40 is capable of generating a make event 50, a break event 52, and a repeat event 54 at the processor 32. When these events are detected, the control program 46 performs the following:

On the make event 50: turn OFF the touchpad 42, turn ON the timer 38;

On the break event 52: turn OFF the touchpad 42, turn ON the timer 38;

On the repeat event 54: turn ON the touchpad 42, turn OFF the timer 38;

On timer 38 expiry: turn ON the touchpad 42.

As the touchpad 42 may be in use during any of these events, execution of the break event 52 is conditional on the touchpad 42 not outputting position/movement signals. That is, when the touchpad 42 is being operated by the user, the break event 52 does not turn off the touchpad 42 and does not turn on the timer 38. The timer 38 expiry event can be realized by counting for a predetermined deactivation interval. When the deactivation interval is reached, the timer 38 turns on the touchpad 42. The deactivation interval can be set to one value or set to different values depending on whether the make event 50 or break event 52 occurs.

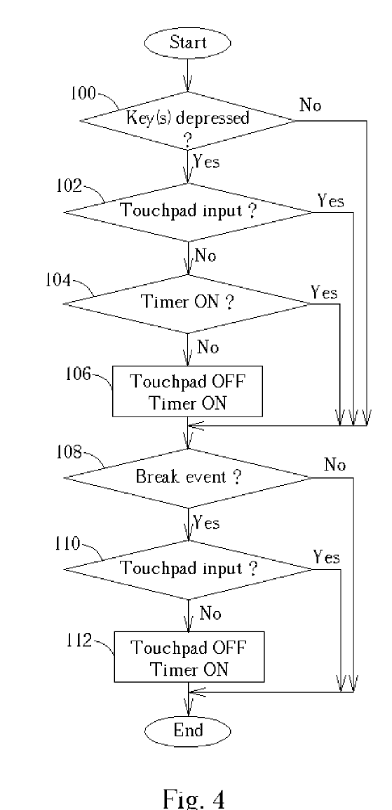

Please refer to FIG. 4 illustrating a flowchart that further defines operation of the control program 46 performing the present invention method. Such a flowchart can be readily converted into a program of a suitableprogramming language (i.e. C, assembly language) and then compiled into executable code by one skilled in the art. The procedure illustrated in FIG. 4 is executed on the make, break, and repeat events 50, 52, 54. In step 100, key states of the keyboard 40 are detected. If a key press is detected in step 100, then step 102 determines if there is user input at the touchpad 42. When no user input is detected at the touchpad 42, step 104 is determines if the timer 38 is already on. Upon determination that the timer 38 is off, step 106 is executed. Step 106 turns the touchpad 42 off and turns the timer 38 on. Next, step 108 determines if the break event 52 is responsible for execution of this procedure. If the break event 52 has occurred, step 110 (like step 102) determines if there is user input at the touchpad 42. Finally, if the touchpad 42 is not being used for input, step 112 turns off the touchpad 42 and turns on the timer 38. The procedure of FIG. 4 evaluates conditions for turning the touchpad 42 off and accordingly turning the timer 38 on, and is independent of timer code.

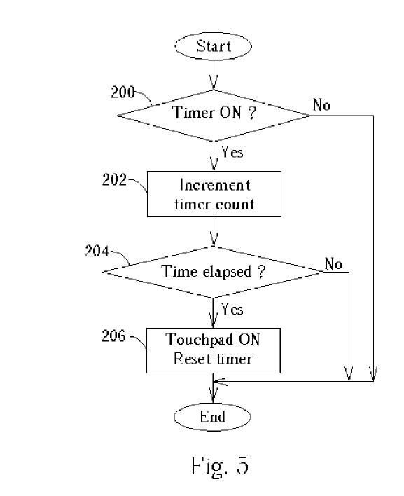

FIG. 5 illustrates flowchart of a periodically executed timer procedure performed in conjunction with the procedure of FIG. 4. The procedure of FIG. 5 could be called by a timer interrupt. In step 200, the procedure determines if the timer 38 on. If the timer 38 is found to be on, step 202 increments the timer count. Then, step 204 checks if the touchpad 42 deactivation interval has been reached. When the deactivation interval has been reached, i.e. the timer 38 has elapsed, step 206 activates the touchpad 42 and resets the timer 38. Together the procedures of FIG. 4 and FIG. 5 realize the operations of the control program 46 as illustrated in FIG. 3.

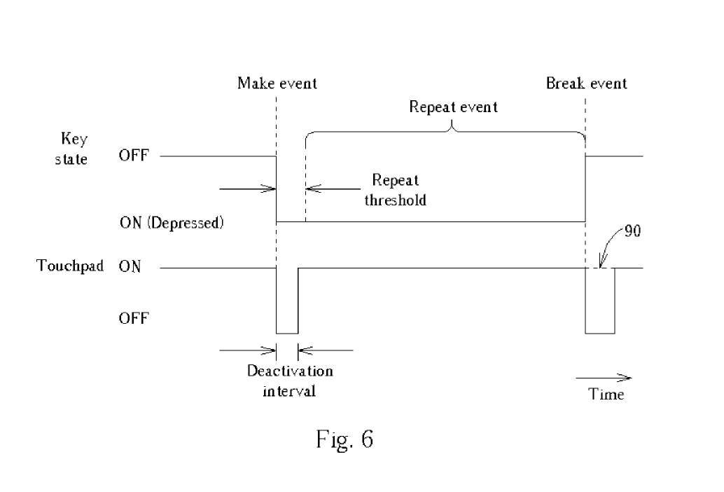

FIG. 6 illustrates a timing diagram of the result achieved by the present invention method. As can be seen, the make event 50 or break event 52 turns off the touchpad 42 for the deactivation interval. Once the deactivation interval has elapsed, the touchpad 42 is reactivated. FIG. 6 shows how activation of the touchpad 42 and deactivation of the timer 38 by the repeat event 54 depends on the lengths of the repeat threshold time and the predetermineddeactivation interval of the touchpad 42. When the repeat threshold time is shorter than the deactivation time, the repeat event 54 reactivates the touchpad 42 and turns off the timer 38. Oppositely, when the repeat threshold time is longer than the deactivation time, the timer reactivates the touchpad 42. As such, depending on the specific application, either detecting the repeat event 54 or the activation of the timer 38 on the make event 50 may be omitted. In addition, the repeat threshold and the deactivation interval may be one and the same. Finally, in FIG. 6, the conditional deactivation of the touchpad on the break event 52 is shown by dashed line 90.

A touchpad and keyboard can be used in combination according to five main scenarios, all of which the present invention addresses. The first scenario is keyboard use only, in which accidental touchpad use is undesirable. Here, turning off the touchpad 42 for the deactivation interval upon a key press or release prevents unwanted input though the touchpad (e.g. shirt sleeve brushing the touchpad). So, during typing where multiple keys are depressed and released continuously, the touchpad 42 remains effectively inactive. The second scenario is touchpad use only. Since the present invention leaves the touchpad 42 turned on by default, uninterrupted touchpad use is possible. The third scenario is a transition from typing to touchpad use. As the user moves his hand from the keyboard 40 to the touchpad 42, the deactivation interval expires and the touchpad 42 becomes activated and ready to accept input. The fourth scenario is a transition from touchpad use to typing, which the present inventionaccommodates. Finally, the fifth scenario is simultaneous touchpad and keyboard use. The fifth scenario is facilitated by the resulting action of the break event 52 being dependent on if the touchpad 40 is in use. The present invention computer 30 and method as executed by the program 46 as described addresses these combination scenarios better than the prior art hot key approach, which tends to make combined touchpad and keyboard use inconvenient.

In contrast to the prior art, the present invention automatically deactivates a touchpad according to keyboard keys being depressed, held depressed, and released. As a result, the present inventioneliminates the need for a manually activated hot key and offers improved convenience over such approach.

Those skilled in the art will readily observe that numerous modifications and alterations of the device may be made while retaining the teachings of the invention. Accordingly, the above disclosure should be construed as limited only by the metes and bounds of the appended claims.

1. A method for cooperatively controlling a touchpad and a keyboard of a computing device, the method comprising:
detecting for an event of at least a key of the keyboard, key events including a make event executed when the key is depressed and a break event executed when the key is released;
deactivating the touchpad upon detection of the make event;
deactivating the touchpad upon detection of the break event when the touchpad is not receiving input; and
reactivating the touchpad immediately after a deactivation interval has elapsed;
wherein the touchpad is normally activated.

2. The method of claim 1 further comprising:
detecting for a repeat event that is executed while a key is depressed for longer than a repeat threshold time; and
reactivating the touchpad upon detection of the repeat event.

3. The method of claim 2 further comprising:
activating a timer upon detection of the make event or the break event; and
deactivating the timer upon detection of the repeat event;
wherein the timer measures the deactivation interval and triggers reactivation of the touchpad.

4. The method of claim 2 wherein the deactivation interval is equal to the repeat threshold time.

5. The method of claim 1 further comprising setting the length of the deactivation interval according to the make or break event being detected.

6. A computing device comprising:
a housing;
a processor including a timer, and a memory fixed in the housing;
a keyboard connected to the processor;
a touchpad connected to the processor; and
a program stored in the memory and executable by the processor for performing the following controls:
deactivating the touchpad for a deactivation interval as measured by a timer, the deactivation interval beginning when a key of the keyboard is depressed or when a key is released while the touchpad is not receiving input; and
activating the touchpad when the key depressed is held depressed for longer than a repeat threshold time, and when the deactivation interval expires.

7. The computing device of claim 6 wherein the memory is a random-access memory (RAM).

8. The computing device of claim 6 wherein the memory is a read-only memory (ROM).

9. The computing device of claim 6 further comprising:
a display device connected to the processor for outputtinginformation relating to input received by the keyboard and touchpad.

10. The computing device of claim 6 wherein the touchpad is fixed in the housing and electrically connected to the processor.

11. The computing device of claim 6 wherein the touchpad is installed in a second housing and electrically connected or wirelessly connected to the processor.
